(19) United States
(12) Patent Application Publication
(10) Pub. No.: US 2026/0202147 A1
(43) Pub. Date: Jul. 16, 2026

(54) COOLING LINE ASSEMBLY

(71) Applicant: HS R & A Co., Ltd., Yangsan-si (KR)

(72) Inventors: Unbae KIM, Yangsan-si (KR); Youngjun KIM, Yangsan-si (KR); Hyukjin JANG, Yangsan-si (KR)

(21) Appl. No.: 19/415,698

(22) Filed: Dec. 10, 2025

(30) Foreign Application Priority Data
Jan. 16, 2025 (KR) 10-2025-0006996

(51) Int. Cl. F28F 9/013; B29C 49/00; F28F 21/06; B29L 23/00

(52) U.S. Cl. CPC F28F 9/013; B29C 49/0015; F28F 21/06; B29L 2023/22; F28F 2255/14

(57) ABSTRACT

A cooling line assembly is disclosed. According to various embodiments of the disclosure, a cooling line assembly may include a plurality of pipes and a plate-shaped reinforcing member positioned between the plurality of pipes and configured to couple at least two of the plurality of pipes to each other. At least one of the plurality of pipes may include a flexible portion configured to be bendable, and the plurality of pipes and the reinforcing member may be integrally formed.

### CROSS-REFERENCE TO RELATED APPLICATIONS

This application claims priority to Republic of Korea Patent Application No. 10-2025-0006996, filed on January 16, 2025, which is incorporated by reference herein in its entirety.

### TECHNICAL FIELD

The disclosure relates to a cooling system, and more particularly, to a cooling line assembly for transporting a coolant.

### BACKGROUND

A vehicle includes various heat-generating components such as an engine, an electric motor, a battery, and/or an electrical control system. Further, the vehicle may include a cooling system for cooling these heat-generating components. The cooling system may include a coolant that absorbs heat from the heat-generating components, and a radiator that releases the heat of the coolant to the outside of the vehicle. Further, the cooling system may include cooling lines (e.g., pipes) that transport the coolant between the heat-generating components and the radiator. The cooling system may include a cooling line assembly that includes a plurality of pipes coupled to or branched from one another.

### SUMMARY

A cooling line assembly including a plurality of pipes may be manufactured by joining the plurality of pipes to each other during manufacturing and forming branch portions at branch points between the plurality of pipes. Because this manufacturing process requires assembling each pipe individually, work efficiency is reduced and the work speed is slowed, resulting in low productivity. Further, the volume occupied by joints or fastening members that connect the pipes may increase the overall volume of the cooling line assembly.

The disclosure provides a modular cooling line assembly that has improved productivity and assemblablity and occupies less space.

In order to achieve the above object, a manufacturing method according to various embodiments of the disclosure is a method of manufacturing a cooling line module including a plurality of pipes and a reinforcing member, which may include an operation of extruding a parison of a polymeric material into a mold, a blow operation of injecting gas into the parison to expand the parison with respect to the mold, and an operation of cooling the polymeric material. The mold may have an internal shape corresponding to the plurality of pipes and the reinforcing member coupled to the plurality of pipes. The blow operation may be configured to simultaneously mold the plurality of pipes and the reinforcing member.

A manufacturing method according to various embodiments of the disclosure is a method of manufacturing a cooling line module including a plurality of pipes and a reinforcing member, which may include an operation of extruding a parison of a polymeric material into a mold, a blowing operation of injecting gas into the parison to expand the parison with respect to the mold, and an operation of cooling the polymeric material. The mold may have an internal shape corresponding to the plurality of pipes and the reinforcing member coupled to the plurality of pipes. The blowing operation may be configured to simultaneously mold the plurality of pipes and the reinforcing member.

A cooling line module according to the disclosure can occupy less space and improve productivity because a plate-shaped reinforcing member and a plurality of pipes can be integrally formed at once by extrusion blow molding from a single parison.

### BRIEF DESCRIPTION OF THE DRAWINGS

In the drawings, the same or similar reference numerals may be used for the same or similar components.

FIG. 1A is a perspective view illustrating a cooling line assembly according to various embodiments.

FIG. 1B is a plan view illustrating a cooling line assembly according to various embodiments.

FIG. 1C is a cross-sectional view illustrating a cooling line assembly according to various embodiments.

FIG. 2A is a flowchart illustrating a method of manufacturing a cooling line assembly according to various embodiments.

FIG. 2B and 2C are schematic diagrams illustrating a manufacturing process of a cooling line assembly according to various embodiments.

FIG. 3A is a perspective view illustrating a pipe of a cooling line assembly according to various embodiments.

FIG. 3B is a cross-sectional view illustrating a pipe of a cooling line assembly according to various embodiments.

### DETAILED DESCRIPTION

Hereinafter, preferred embodiments of the disclosure will be described in detail with reference to the attached drawings.

The embodiments of the disclosure are provided to more fully describe the disclosure to those skilled in the art. The embodiments described below may be modified in various forms, and the scope of the disclosure is not limited to the embodiments described below. Rather, these embodiments are provided to more faithfully and completely convey the spirit of the disclosure to those skilled in the art. Accordingly, descriptions of well-known techniques that may obscure the gist of the disclosure may be omitted, at least in part, in this specification.

Further, thicknesses and sizes of the respective layers in the drawings are exaggerated for convenience and clarity of explanation, and like reference numerals in the drawings denote like elements. As used herein, the term "and/or" includes any one of the listed items and any combination of one or more of the listed items. The terminology used herein is for the purpose of describing particular embodiments and is not intended to limit the disclosure. As used herein, the singular forms are intended to include the plural forms unless the context clearly dictates otherwise. Furthermore, as used herein, the terms "comprise" and/or "comprising" specify the presence of stated shapes, numbers, steps, operations, members, components, and/or groups thereof, but do not preclude the presence or addition of one or more other shapes, numbers, steps, operations, members, components, and/or groups thereof.

Although terms such as “first”, “second”, and the like may be used herein to describe various members, components, regions, and/or portions, it is to be understood that these members, components, regions, and/or portions are not limited by such terms. These terms are merely used to distinguish one member, component, region, or portion from another. Accordingly, a first member, component, region, or portion to be described below may refer to a second member, component, region, or portion without departing from the teachings of the disclosure.

Further, in the case where it is stated that a layer is formed or disposed on another layer, an intermediate layer may be formed or disposed between the layers. Similarly, in the case where it is stated that a material is adjacent to another material, an intermediate material may be present between the materials. Conversely, in the case where it is stated that a layer or material is formed or disposed "directly" or "immediately" on another layer or material, or is "directly" adjacent or in contact with another layer or material, it should be understood that no intermediate material or layer is present between them.

Hereinafter, embodiments of the disclosure will be described with reference to the drawings schematically illustrating ideal embodiments of the disclosure. In the drawings, for example, the sizes and shapes of members may be exaggerated for convenience and clarity of explanation, and variations of the illustrated shapes may be expected in actual implementations. Therefore, the embodiments of the disclosure should not be construed as being limited to specific shapes of regions illustrated in this specification.

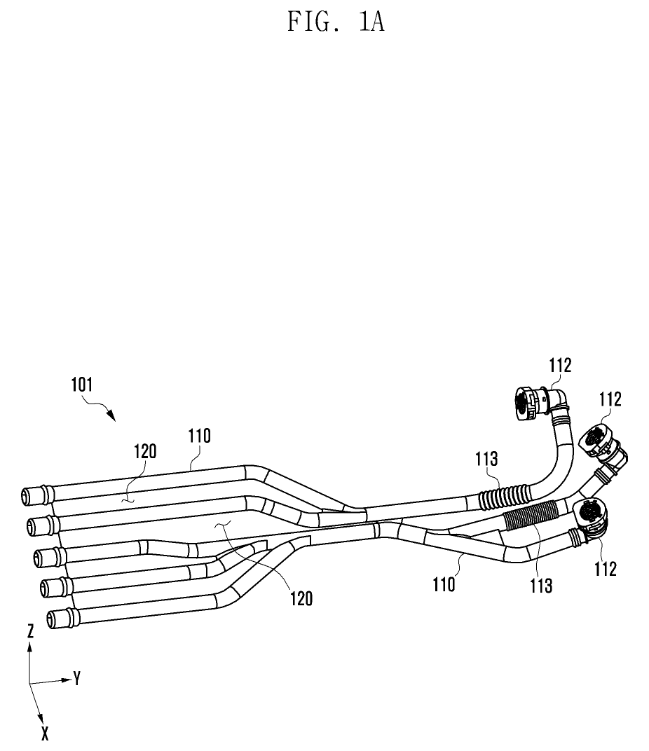

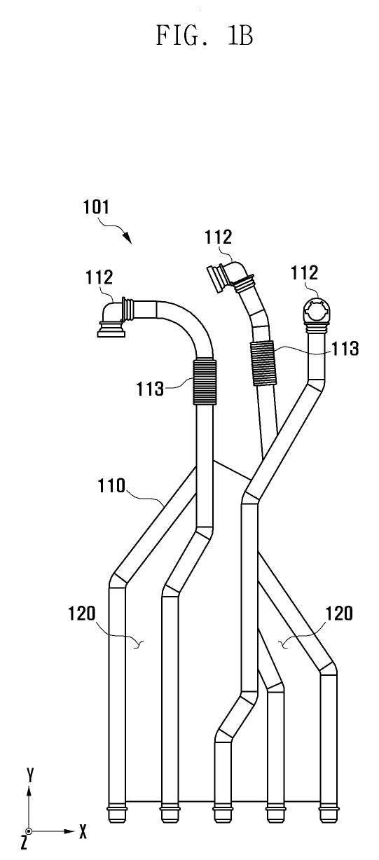

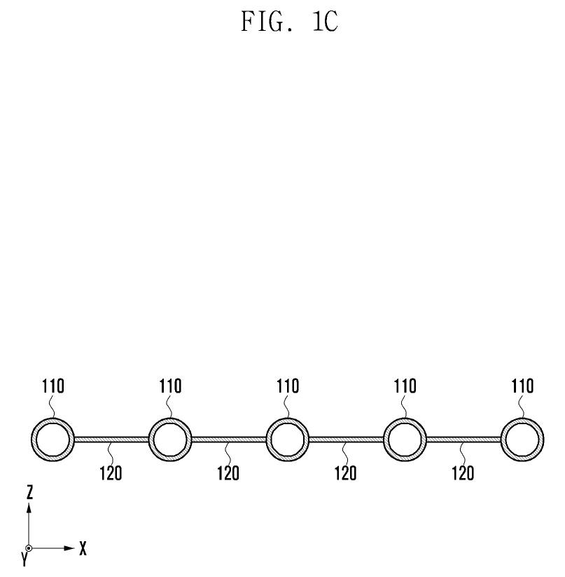

FIG. 1A is a perspective view illustrating a cooling line assembly 101 according to various embodiments.

FIG. 1B is a plan view illustrating a cooling line assembly 101 according to various embodiments.

FIG. 1C is a cross-sectional view illustrating a cooling line assembly 101 according to various embodiments.

With reference to FIGS. 1A to 1C, the cooling line assembly 101 may include a plurality of pipes 110. The pipes 110 are tubular members that transport fluid, and the cooling line assembly 101 may include, for example, pipes that transport a coolant. A connecting portion 112 (e.g., pipe fitting) may be located at an end portion of at least some of the plurality of pipes 110. At least some of the plurality of pipes 110 may branch off from or merge with other pipes 110 of the cooling line assembly 101.

In various embodiments, the plurality of pipes 110 may be made of a polymeric material. For example, the plurality of pipes 110 may be made of a polymeric material such as polypropylene, polyethylene, polyvinyl chloride, polyamide, and/or polyphenylene sulfide.

In various embodiments, the cooling line assembly 101 may include a reinforcing member 120. The reinforcing member 120 may be a member that is coupled to at least some of the plurality of pipes 110 to maintain the integrity of the cooling line assembly 101 and reinforce its rigidity. The reinforcing member 120 may be configured to connect at least two of the plurality of pipes 110. For example, the reinforcing member 120 may extend from an outer side surface of one of the plurality of pipes 110 to be coupled to an outer side surface of another one of the plurality of pipes 110.

In various embodiments, the reinforcing member 120 and the plurality of pipes 110 of the cooling line assembly 101 may be integrally formed. By integrally forming the cooling line assembly 101 and the reinforcing member 120, the productivity of the cooling line assembly 101 may be improved. For example, as described below, the plurality of pipes 110 and the reinforcing member 120 of the cooling line assembly 101 may be integrally formed by means such as injection blow molding or extrusion blow molding.

In various embodiments, the plurality of pipes 110 may be positioned on a plane (e.g., the x-y plane in the drawing), and the reinforcing member 120 located between the plurality of pipes 110 may have a plate shape parallel to the plane. Because at least a portion of the plurality of pipes 110 is positioned on a plane, it may facilitate integral molding with the plate-shaped reinforcing member 120 that connects the plurality of pipes 110. Further, by positioning the plurality of pipes 110 and the reinforcing member 120 on the same plane, the thickness of the cooling line assembly 101 may be reduced. Accordingly, the cooling line assembly 101 may be easily installed in a limited space.

In various embodiments, at least some of the plurality of pipes 110 may include a flexible portion 113. The flexible portion 113 may be a part of the pipe 110 configured to be bendable. For example, the flexible portion 113 may include a corrugated pipe. The corrugated pipe may be a portion of the pipe 110 in which corrugations are formed on an outer wall to facilitate bending. The flexible portion 113 may allow the pipe 110 of the cooling line assembly 101 to be bent so as to be coupled to components of the cooling system (e.g., radiator, tank, thermostat, pump, and/or other piping) located in various directions.

For example, a portion of a plurality of pipes 110 interlinked by the reinforcing member 120 is located on a plane (e.g., the x-y plane), and a pipe 110 connected to another component of the cooling system located outside the plane may be bent by including the flexible portion 113.

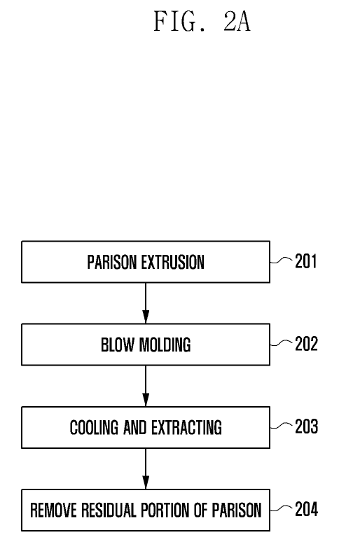

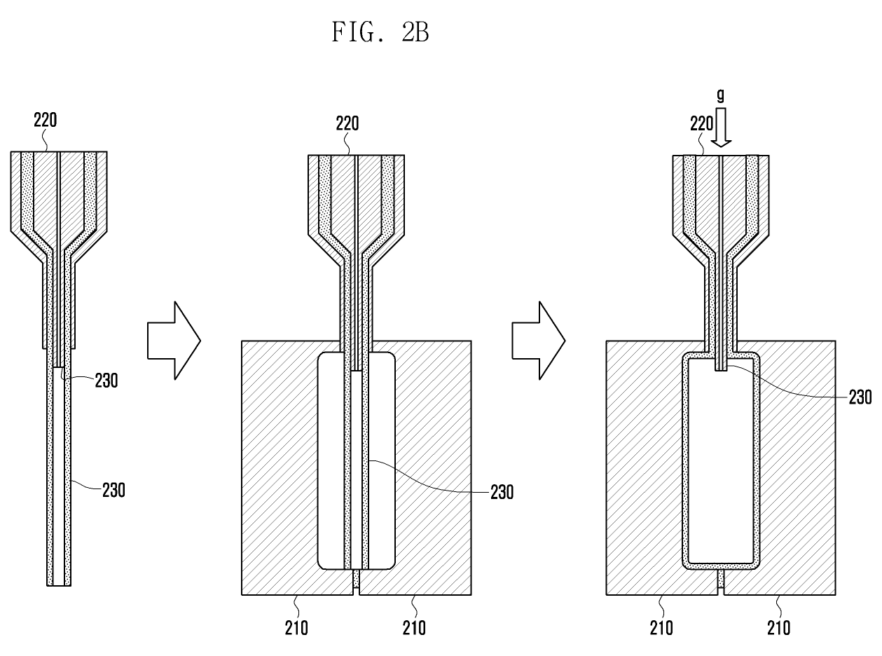

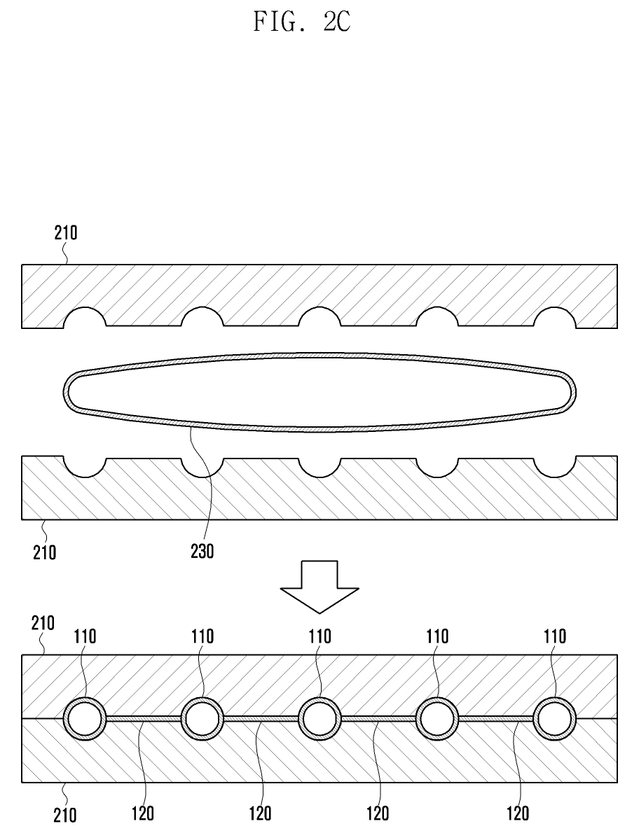

FIG. 2A is a flowchart illustrating a method of manufacturing a cooling line assembly 101 according to various embodiments.

FIG. 2B and 2C are schematic diagrams illustrating a manufacturing process of a cooling line assembly 101 according to various embodiments.

With reference to FIGS. 2A and 2B, the cooling line assembly 101 according to various embodiments of the disclosure may be manufactured by an extrusion operation 201 and a blowing operation 202. The extrusion operation 201 may include an operation of melting a polymeric material (e.g., polypropylene, polyethylene, polyvinyl chloride, polyamide, and/or polyphenylene sulfide) of the cooling line assembly 101 and extruding the molten material into a parison 230. For example, the polymeric material may be extruded through a ring-shaped extrusion nozzle 220 into a parison 230 having a hollow portion 231.

The blowing operation 202 may be an operation of forming a shape corresponding to an internal shape of a mold 210 by injecting gas into the parison 230 within the mold 210 and expanding the parison 230. For example, the extrusion nozzle 220 may include a gas inlet 221, and air may be injected into the parison 230 extruded through the extrusion nozzle 220 via the gas inlet 221, thereby expanding the parison 230.

After the blowing operation 202 is completed, the cooling line assembly 101 may be cooled and extracted from the mold 210 (203). After the cooling line assembly 101 is extracted from the mold 210, an operation 204 of cutting a residual portion (e.g., runner or burr) of the parison 230 may be performed.

With reference to FIG. 2C, the mold 210 may have an internal shape corresponding to the plurality of pipes 110 of the cooling line module and the reinforcing member 120 coupled to the plurality of pipes 110. For example, the mold 210 may include a plurality of cylindrical recesses corresponding to the plurality of pipes 110 and a plate-shaped recess extending from the plurality of cylindrical recesses. When gas G is injected into the parison 230 while the mold 210 is in a closed state, the parison 230 may be formed into shapes of the plurality of pipes 110 along the shape of the mold 210, and both surfaces of the parison 230 between the plurality of pipes 110 may be bonded together to form the reinforcing member 120.

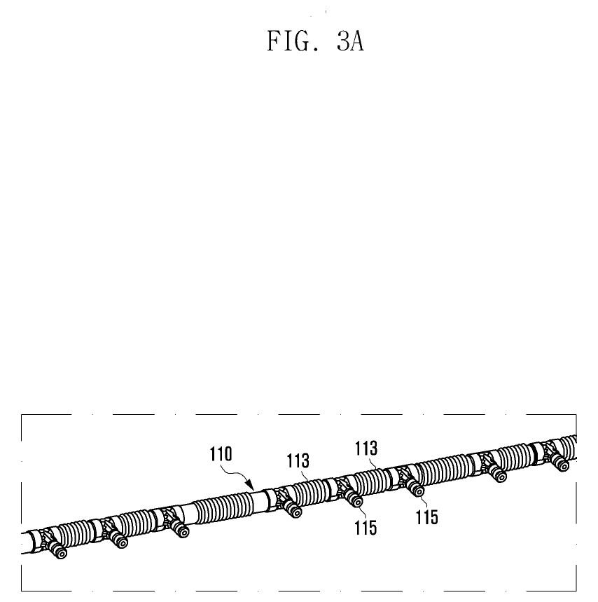

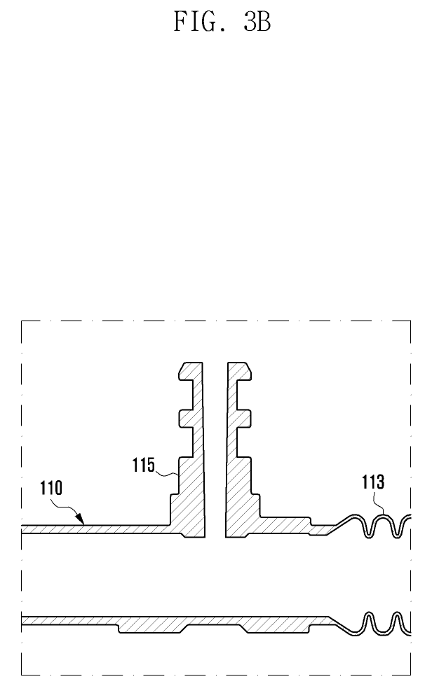

FIG. 3A is a perspective view illustrating a pipe 110 of a cooling line assembly 101 according to various embodiments.

FIG. 3B is a cross-sectional view illustrating a pipe 110 of a cooling line assembly 101 according to various embodiments.

With reference to FIGS. 3A and 3B, at least one of the pipes 110 of the cooling line assembly 101 may include a branch port portion 115. The branch port portion 115 may be a portion that is connected to other piping and/or components of a cooling system and that branches from the pipe 110 of the cooling line assembly 101.

In various embodiments, the branch port portion 115 may be integrally formed with the pipe 110 of the cooling line assembly 101. For example, the cooling line assembly 101 may be manufactured by blow molding using the mold 210 having an internal shape corresponding to the branch port.

In various embodiments, the pipe 110 may include a plurality of branch port portions 115 and flexible portions 113 (e.g., corrugated pipe), and the plurality of branch port portions 115 within the pipe 110 may be positioned so as to be spaced apart from each other by the flexible portions 113. For example, the pipe 110 may include branch port portions 115 and flexible portions 113 that are alternately positioned. By disposing the branch port portions 115 alternately with the flexible portions 113, positions and directions of the plurality of branch port portions 115 may be effectively adjusted, and thus, cooling lines may be effectively branched for components of the cooling system disposed at different positions and directions.

According to various embodiments of the disclosure, a cooling line assembly 101 may include a plurality of pipes 110 and a plate-shaped reinforcing member 120 positioned between the plurality of pipes 110 and configured to couple at least two of the plurality of pipes 110 to each other. At least one of the plurality of pipes 110 may include a flexible portion 113 configured to be bendable. The plurality of pipes 110 and the reinforcing member 120 may be integrally formed.

In various embodiments, the reinforcing member 120 may extend from a side surface of one of the plurality of pipes 110 to be coupled to a side surface of another one of the plurality of pipes 110.

In various embodiments, the plurality of pipes 110 may have at least a portion disposed on a first plane, and the reinforcing member 120 may be parallel to the first plane.

In various embodiments, the plurality of pipes 110 and the reinforcing member 120 may be manufactured by an operation of extruding a parison 230 of a polymeric material into a mold 210 and a blowing operation of injecting gas into the parison 230 to mold the polymer.

In various embodiments, the flexible portion 113 may include corrugations formed on an outer wall of the pipe 110.

In various embodiments, at least one of the plurality of pipes 110 may include a branch port portion 115 that branches from the pipe 110, and the branch port portion 115 may be integrally formed with the pipe 110.

A manufacturing method according to various embodiments of the disclosure is a method for manufacturing a cooling line module including a plurality of pipes 110 and a reinforcing member 120, which may include an operation of extruding a parison 230 of a polymeric material into a mold 210; a blow operation of injecting gas into the parison 230 to expand the parison 230 with respect to the mold 210; and an operation of cooling the polymeric material. The mold 210 may have an internal shape corresponding to the plurality of pipes 110 and the reinforcing member 120 coupled to the plurality of pipes 110. The blow operation may be configured to simultaneously mold the plurality of pipes 110 and the reinforcing member 120.

Further, it will be apparent to those skilled in the art that the components of the disclosure described in this specification and drawings may be combined with each other in ways different from those illustrated herein, or that some components may be omitted. Furthermore, the embodiments disclosed in this specification and drawings are merely specific examples provided to facilitate explanation and understanding of the embodiments of the disclosure, and are not intended to limit the scope of the embodiments described herein. Therefore, the scope of the various embodiments disclosed in this document should be interpreted as including all modifications and variations derived from the technical concepts of the various embodiments disclosed herein, in addition to the embodiments specifically disclosed.

### DESCRIPTION OF SYMBOLS

101: Cooling line assembly

110: Pipe

112: Connecting portion

113: Flexible portion

115: Branch port portion

120: Reinforcing member

What is claimed is:

1. A cooling line assembly, comprising:
a plurality of pipes; and
a plate-shaped reinforcing member positioned between the plurality of pipes and configured to couple at least two of the plurality of pipes to each other,
wherein at least one of the plurality of pipes comprises a flexible portion configured to be bendable, and
the plurality of pipes and the reinforcing member are integrally formed.

2. The cooling line assembly of claim 1, wherein the reinforcing member extends from a side surface of one of the plurality of pipes to be coupled to a side surface of another one of the plurality of pipes.

3. The cooling line assembly of claim 2, wherein the plurality of pipes have at least a portion disposed on a first plane, and
the reinforcing member is parallel to the first plane.

4. The cooling line assembly of claim 1, wherein the plurality of pipes and the reinforcing member are manufactured by:
an operation of extruding a parison of a polymeric material into a mold; and
a blowing operation of injecting gas into the parison to mold the polymeric material.

5. The cooling line assembly of claim 1, wherein the flexible portion comprises corrugations formed on an outer wall of the pipe.

6. The cooling line assembly of claim 1, wherein at least one of the plurality of pipes comprises a branch port portion branching from the pipe, and
the branch port portion is integrally formed with the pipe.

7. A method of manufacturing a cooling line module including a plurality of pipes and a reinforcing member, the method comprising:
an operation of extruding a parison of a polymeric material into a mold;
a blowing operation of injecting gas into the parison to expand the parison with respect to the mold; and
an operation of cooling the polymeric material,
wherein the mold has an internal shape corresponding to the plurality of pipes and the reinforcing member coupled to the plurality of pipes, and
the blowing operation simultaneously molds the plurality of pipes and the reinforcing member.
